(19) United States
(12) Patent Application Publication
(10) Pub. No.: US 2017/0084128 A1
(43) Pub. Date: Mar. 23, 2017

(54) SYSTEM AND METHOD FOR IMPLEMENTING AN AUTOMATED GAMBLING ENVIRONMENT FOR A VIDEO GAMING EVENT

(71) Applicant: Kentrail Wilson, Smyrna, TN (US)

(72) Inventor: Kentrail Wilson, Smyrna, TN (US)

(21) Appl. No.: 14/858,783

(22) Filed: Sep. 18, 2015

(51) Int. Cl. G07F 17/32

(52) U.S. Cl. CPC G07F 17/3288; G07F 17/3258; G07F 17/323; G07F 17/3276

(57) ABSTRACT

The present invention relates to a system and method for implementing a safe and trusted gambling environment for users to participate in an online betting activity associated with the video gaming event. The system automatically sends a notification request to one or more participant(s) in the background within a network to participate in the online betting activity based on the wager amount available with the participant(s). Further, the system allows the participant(s) to either accept or decline the notification request to participate in the online betting activity. Further, the system tracks the wager outcome of the online betting activity and transfers the funds from the initializing user to the winning participant.

### FIELD OF THE INVENTION

The present invention generally relates to a system and method for implementing a safe and trusted automated gambling environment for a video gaming event and more particularly relates to registering a user to the gambling environment for initiating an online betting activity associated with a gaming event by automatically sending participation request to one or more participants in the background within a network, based on the criteria defined by the registered user.

### BACKGROUND OF THE INVENTION

There are many online betting portals available in the market for the users to gamble and the existing online betting portals requires an external/third-party service providers for checking the participants. Getting participants to compete in the online betting portals can be time consuming and requires user's intervention to select the required participants based on the requirement. Hence, there is a need for a system that can quickly and easily identify the participants for an online betting activity in a gaming scenario. Further, the system must be capable of determining the participants based on various criterion defined by the user.

The system must be capable of registering the user(s) intending to participate in the video gaming event and must store the registered user(s) in a database. Further, the system must allow the initiating user to search the database for inviting potential participant(s) based on the criteria specified by the user through the profile page of the initiating user, wherein the criteria can be set by using the flags. The criteria can define various factors such as the games the user is interested in and the wager range the user is willing to compete in.

Further, the proposed system must be capable of allowing the initializing user to send invitation to the participant(s) by selecting the registered participant(s) from the database and/or by specifying the registered participant names to be extracted from the database. Additionally, the proposed system must be capable of inviting the registered participant(s) based on the criteria specified by the initializing user, wherein the flags created for the registered participant(s) in the participant(s) profile page must match with the criteria specified by the initializing user.

### SUMMARY OF THE INVENTION

The present invention relates to a system and method for implementing a safe and trusted gambling environment for a user participating in the video gaming event(s) on an electronic device by automatically sending participation request to a plurality of a participants in the background within a network, wherein the system is configured to register the user with the system to initiate an online betting activity associated with the video gaming event(s). Further, the system is configured to register the unregistered users/participants to participate in the online betting activity, and to automatically invite the plurality of participants, in the background, to participate in the online betting activity depending on the choice made by the initializing user. Further, the system is configured to define an eligibility criteria for the plurality of participants/users to participate in the online betting activity based on the wager amount available in the digital athlete account, and based on the age factor of the plurality of participants/users, wherein the age of the plurality of participants must be 18 years or older. Further, the system is configured to invite the plurality of participants based on the criteria specified by the initializing user and/or by allowing the initializing user to explicitly specify the names of the plurality of participants, wherein the initiating user sends the invitation to the plurality of unregistered user(s) by specifying an email address of the unregistered participant(s). Further, when the unregistered participant(s) receives the email, the unregistered participant(s) will be prompted to register by providing the required information. Further, the system is configured to check the digital athlete account fund available with the unregistered participant(s) to participate in the online betting activity and the system continues to send the invitation to the intended participant(s). Further, the system is configured to allow the invited participant(s) to increase the funds in the digital athlete account as required if the invited participant(s) is willing to participate in the online betting activity. Further, there will also be different rooms that are categorized by game and wage tier. User will be able to choose participants from the rooms and add them to a contract. Further, the system is configured to track the online betting activity to determine the wager outcome. Based on the wager outcome determined for the online betting activity, a fund transaction is initiated between the initializing user and the winner of the online betting activity associated with one or more video gaming event(s). Further, the system is configured to complete the fund transaction initiated between the initializing user and the winner of the online betting activity in a safe and secure manner.

### BRIEF DESCRIPTION OF DRAWINGS

FIG. 1 illustrates a working overview of the system 100 used to implement a safe and trusted gambling environment for the video gaming event(s) on an electronic device by automatically sending participation request to a plurality of a participants in the background within a network 101.

FIG. 2 illustrates a flow-chart 200 that explains the process of implementing a safe and trusted gambling environment for a user participating in the video gaming event(s) on an electronic device by automatically sending participation request to a plurality of a participants in the background within a network 101.

FIG. 3 illustrates a system overview of components 300 used to implement the method of implementing a safe and trusted gambling environment for the video gaming event(s) on an electronic device by automatically sending participation request to a plurality of a participants in the background within a network 101.

### FIGURE DESCRIPTION

100—A system overview

101—A network for implementing the method

102—An online betting activity initializing user

103—A plurality of participants invited to participate in the online betting activity

104—A video gaming event initiated on the electronic device

105—A wager outcome associated with the video gaming event

106—A system database used for maintaining the balance account records of the participants and the registered user and all related info registered users. Console, Paypal Email, Notification preferences, Gamertag

200—A process for implementing the method

300—A system overview of components used for implementing the method

301—A Display module

302—A Registration module

303—A Contract Creator module

304—A Storage Database module

305—A Match Tracking module

306—A Fund Tracking module

307—A Communication module

308—A Controlling module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

In an embodiment, the term electronic device refers to a device that can be used to initiate and support an online betting activity for a video gaming event 104 within a network 101. For example, the electronic device can be a smart phone, a mobile phone, a laptop, a tablet, a personal computer, or the like.

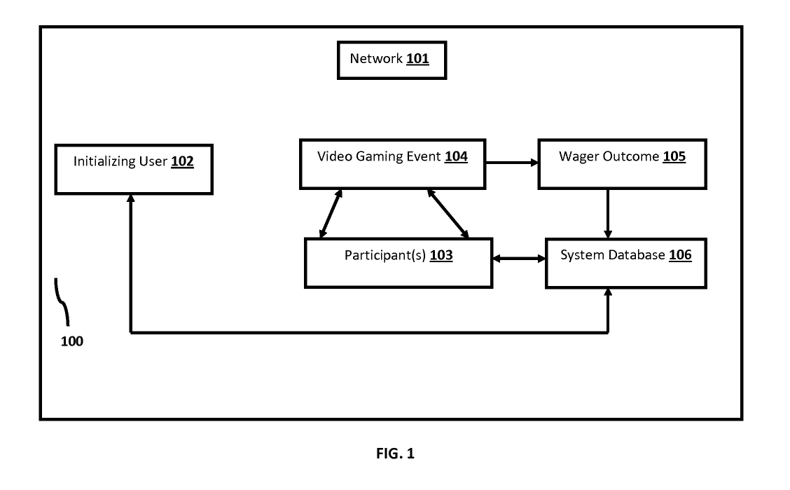

Referring to FIG. 1 illustrates a working overview of the system 100 used to implement a safe and trusted gambling environment for the video gaming event(s) on an electronic device by automatically sending participation request to a plurality of participants in the background within a network 101. As depicted in the figure, the system 100 allows an unregistered user to register by validating the user's PayPal account, verifying the age, collecting users console type and the gamer tag of the user to participate in an online betting activity associated with a gaming event. In an embodiment, as the initial user 102 initiates an online betting activity, the system 100 automatically sends a notification request to one or more unregistered participants in the background within the network 101. In an embodiment, the system 100 sends the notification request to one or more unregistered participants 103, and verifies the digital athlete account balance records associated with the participants within the network 101 and along with the age factor associated with the plurality of participants/users, wherein the age of the plurality of participants/users must be 18 years or older and the details of the registered participants/users are stored in the System database 106. In an embodiment, the System database 106 stores information of all the registered participant(s) within the network 101, wherein the information includes the digital athlete account balance records and/or the age factor associated with the participants within the network 101. Further, the system 100 allows the initializing user 102 to retrieve the participant(s) details from the system database 106 based on the criteria specified or based on the explicitly specified list of participant(s) by the initializing user 102.

In an embodiment, the system 100 allows the user to handle any of the foreground related activities while the system 100 is assisting the user to identify the relevant participants 103 to compete in the online betting activity. For example: the system 100 allows the user to send mails in the foreground while the system 100 is assisting the user to identify the relevant participants 103. Further, the system 100 allows the requested participants 103 to either approve or decline the request notification. Upon accepting the notification request, the system 100 allows the participants 103 to compete in the initiated online betting activity associated with the video gaming event. In an embodiment, as the online betting activity is initiated for the video gaming event 104, the system 100 tracks the wager outcome for the video gaming event 104. Based on the results of the wager outcome determined for the video gaming event 104, the system 100 initiates a fund transaction activity between the registered user 102 and the participants 103 to transfer the fund from the System database 106 to the winner of online betting activity, in a safe and secure manner. In an embodiment, each of the participants participating in the online betting activity is assigned with a unique contract number, which is used to uniquely identify the participants for handling the fund transaction.

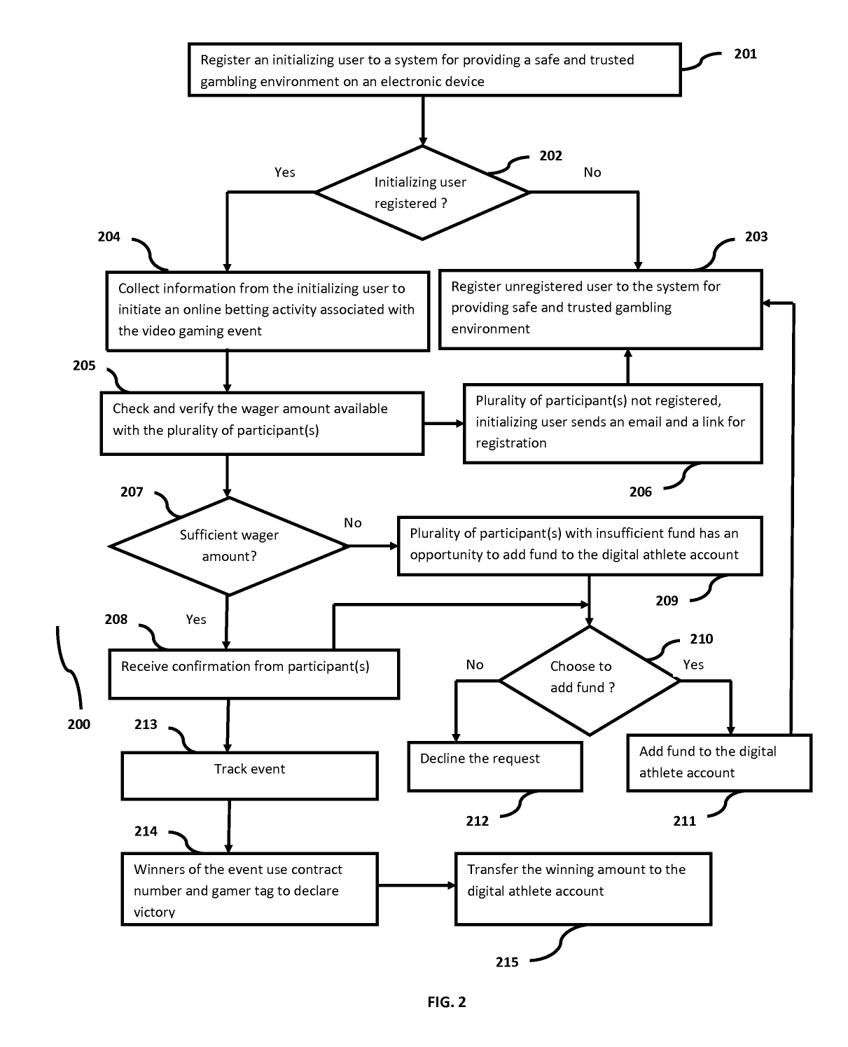

Referring to FIG. 2 illustrates a flow-chart 200 that explains the process of implementing a safe and trusted gambling environment for a user participating in the video gaming event(s) on an electronic device by automatically sending participation request to a plurality of a participants in the background within a network 101. Initially, at step 201, a user is registered with the system 100 for initiating a safe and trusted gambling environment for a video gaming event on an electronic device. At step 202, the system 100 checks if the initializing user 102 is registered successfully. If the system 100 determines that the initializing user is not registered successfully then at step 203, the system 100 registers the initializing user 102 by providing the necessary information. Otherwise, at step 204, the system 100 is configured to collect information such as the gamer tag, PayPal account, console type, the wager amount, or the like from the initializing user 102. As the balance account information of the initializing user is verified, the system 100 is configured to automatically send a notification request to a plurality of participants 103 in the background based on the criteria defined by the user for selecting the participants 103 or based on the explicitly specified plurality of participants by the initializing user 102. In an embodiment, the criteria defined by the initializing user 102 includes but not limited to the wager amount required by the participants 103 to participate in the online betting activity, pre-defined rules defined for selecting the participants, actual game proposed by the initiating user, or selecting all the participants within the network 101. At step 205, the system 100 is configured to check and verify the wager amount available in the plurality of participants digital athlete account. Further, at step 206, the system 100 is configured to check if the plurality of participants, explicitly specified by the initializing user 102 or selected by the system 100 based on the criteria defined by the initializing user 102, is registered with the system 100 or not. Further, based on the criteria specified by the user 102 or explicitly specified by the user 102, the system 100 is configured to send a notification request to one or more participants 103 within the network 101. In an embodiment, the system 100 is configured to send a notification request in the form of a contract to all participants with a unique contract number, and the contract can be sent to the participant(s) through an email, a social media, a phone alert from an application, or a messenger on a website application. Further, if the plurality of participants is not registered then the system 100 allows the plurality of participants to register successfully by providing the necessary information to the contract sent by the initializing user 102. Further, at step 207, the system 100 determines if there is sufficient wager amount available in the plurality of participants digital athlete account. Further, if the system 100 determines that there is sufficient wager amount available in the digital athlete account of the plurality of participants, at step 208, the plurality of participants can send a confirmation to participate in the online betting activity. Further, at step 209, the system 100 allows the plurality of participants to add the wager amount to the digital athlete account. If the plurality of participants intends to add fund to the digital athelete account at step 210, the system 100 allows the plurality of participants to add the fund into the digital athlete account at step 211. However, if the plurality of participants does not intend to add fund into the digital athlete account then the plurality of participants can be declined from participating in the online betting activity at step 212. At step 213, the system 100 is configured to initiate and track the online betting activity associated with the video gaming event. As the system 100 tracks the winner of the online betting activity, at step 214, the system 100 is configured to initiate a fund transaction between the initializing user 102 and the winner of the online betting activity. Further, at step 215, the system 100 is configured to ensure that the fund transaction is completed safely and securely within the network 101.

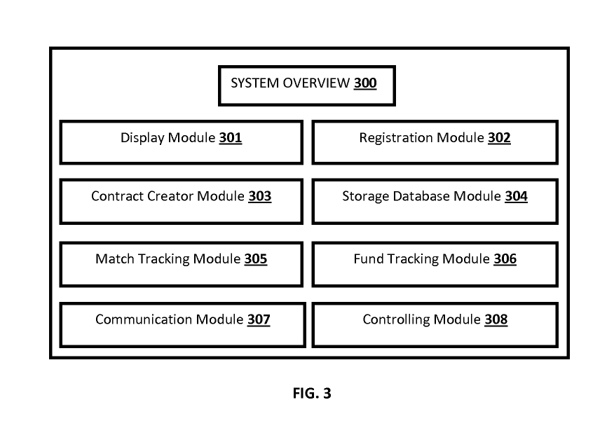

Referring to FIG. 3 illustrates a system overview 300 of components used to implement the method of implementing a safe and trusted gambling environment for the video gaming event(s) on an electronic device by automatically sending participation request to a plurality of a participants within the network 101. The system comprises of the following components: a Display module 301, a Registration module 302, a Contract Creator module 303, a Storage Database module 304, a Match Tracking module 305, a Fund Tracking module 306, a Communication module 307, and a Controlling module 308. In an embodiment, the Display module 301 is configured to display a web interface or an application to allow the user to register with the system 100 by completing the required formalities. Further, the system 100 allows the participants to view the notification request and to send the confirmation for the notification request through the Display module 301. In an embodiment, the Registration module 302 allows the user to register with the system 100. In an embodiment, the Contract Creator module 303 is configured to send notification request to the participants for competing in the online betting activity associated with the video gaming activity. In an embodiment, the Storage Database module 304 is configured to store the balance records of the user and the participants along with the unique contract number assigned to each of participants participating in the online betting activity. In an embodiment, the Match Tracking module 305 is configured to match the opponents for the registered user who has initiated the video gaming activity and to track the wager outcome of the online betting activity associated with the video gaming activity. In an embodiment, the Fund Tracking module 306 is configured to initiate a fund transaction activity between the user and the winner of the online betting activity associated with the video gaming activity and is configured to ensure that the initiated fund transaction activity is tracked to closure. In an embodiment, the Communication module 307 is configured to provide networking communication across various modules supported within the network 101. In an embodiment, the Controlling module 308 is configured to transfer data across various modules supported within the network 101.

1. A system implemented for providing a safe and trusted gambling environment for an initializing user participating in an online betting activity associated with at least one video gaming event on an electronic device by automatically sending participation request to a plurality of a participants in the background within a network, wherein said system is configured to:
register said initializing user with the system to initiate an online betting activity associated with said at least one video gaming event;
collect information from said initializing user to allow said initializing user to initiate said online betting activity associated with said at least one video gaming event;
invite said plurality of participants to participate in said online betting activity depending on the choices made by said initializing user;
notify said plurality of participants to participate in said online betting activity after determining the wager amount and age factor associated with said plurality of participants;
verify the wager amount available with said plurality of participants to participate in said online betting activity;
allow said plurality of participants to upgrade the wager amount based on the wager amount required for said online betting activity;
track said online betting activity that is initiated within said network;
initiate a fund transaction between said initializing user and said plurality of participants participating in said online betting activity based on the wager outcome associated with said at least one video gaming event; and
complete the fund transaction initiated between said initializing user and said plurality of participants participating in said at least one video gaming event.

2. The system as claimed in claim 1, wherein said system can be configured to receive information from said initializing user through a user interface designed in the form of a website service or a client application for allowing said initiating user to initiate said online betting competition associated with said at least one video gaming event.

3. The system as claimed in claim 2, wherein the system allows said initializing user and said plurality of participants participating in said online betting competition to compete in at least one mode facilitated by the system.

4. The system as claimed in claim 3, wherein said online betting competition competitors can be represented in at least one mode that can be one of: a face-to-face mode, an online mode, a multiplayer online mode.

5. The system as claimed in claim 1, wherein the information collected from said initializing user participating in said at least one video gaming event comprises of validating the balance funds associated with said initializing user's digital athlete account, receiving a gamer tag, PayPal account verification details, console type, or the like.

6. The system as claimed in claim 1, wherein the system is configured to perform the fund transaction by implementing a safe and secure mechanism for transferring the fund between said initializing user and said at least a plurality of participants participating in said at least one video gaming event.

7. The system as claimed in claim 1, wherein the system is configured to define the criteria for notifying said plurality of participants based on at least one of the following factors: balance funds available in the digital athlete account database of said plurality of participants, which can be used as wager amount in the video gaming event, special rules defined by said initializing user, choice of the initiating user specified in the form.

8. The system as claimed in claim 7, wherein the plurality of participants notified to participate in said online betting activity are sent with a notification message to every participant, which is associated with a unique contract number of said plurality of participants through a networking application, such as a social media application, a text application, an email application, or the like.

9. The system as claimed in claim 8, wherein the notification message sent to said plurality of participants to participate in said online betting activity can be either accepted or rejected by said plurality of participants.

10. The system as claimed in claim 9, wherein the information of said plurality of participants participating in said online betting activity is sent to a system database for verifying the wager amount available with said plurality of participants to participate in said online betting activity.

11. The system as claimed in claim 10, wherein the system is configured to initiate the fund transaction between said initializing user and said plurality of participants, who are declared to be the winners of the online betting activity associated with said at least one video gaming event, by updating the gamer tag and the unique contract number of the winners in the system database.

12. The system as claimed in claim 11, wherein the system is configured to notify said plurality of participants with the winning/victory evidence by sharing the victory screenshots and ensures that the declared winner(s) receive the allotted funds.

13. The system as claimed in claim 1, wherein the system is configured to allow the user to perform any of the foreground activities while the system is sending notification to said plurality of participants within the network.

14. A method implemented for providing a safe and trusted gambling environment for an initializing user participating in an online betting activity associated with at least one video gaming event on an electronic device by automatically sending participation request to a plurality of a participants in the background within a network, wherein said method comprises of:
registering said initializing user with the system to initiate said online betting activity associated with said at least one video gaming event;
collecting information from said initiating user to allow said initializing user to initiate said online betting competition associated with said at least one video gaming event;
inviting said plurality of participants to participate in said online betting activity depending on the choices made by said initializing user;
notifying said plurality of participants to participate in said online betting activity after determining the wager amount and age factor associated with said plurality of participants;
verifying the wager amount available with said plurality of participants to participate in said online betting activity;
allowing said plurality of participants to upgrade the wager amount based on the wager amount required for said online betting activity;
tracking said online betting activity that is initiated within said network;
initiating a fund transaction between said initializing user and said plurality of participants participating in said online betting activity based on the wager outcome associated with said at least one video gaming event; and
completing the fund transaction initiated between said initializing user and said plurality of participants participating in said at least one video gaming event.

15. The method as claimed in claim 14, wherein said method receives information from said initiating user through a user interface designed in the form of a website service, a client application for allowing said initializing user to initiate said online betting competition associated with said at least one video gaming event.

16. The method as claimed in claim 15, wherein the method allows said initializing user and said plurality of participants to participate in said online betting competition to compete in at least one mode facilitated by the system.

17. The method as claimed in claim 16, wherein said online betting competition competitors can be represented in said at least one mode that can be one of: a face-to-face, an online mode, a multiplayer online mode.

18. The method as claimed in claim 15, wherein the information collected from said initializing user participating in said at least one video gaming event comprises of validating the balance funds associated with said initiating user's digital athlete account, receiving a gamer tag, PayPal account verification details, console type, or the like.

19. The method as claimed in claim 14, wherein the method performs the fund transaction by implementing a safe and secure mechanism for transferring the fund between said initializing user and said at least a plurality of participants participating in said at least one video gaming event.

20. The method as claimed in claim 14, wherein the method defines the criteria for notifying said plurality of participants based on at least one of the following factors: balance funds available in the digital athlete account database of said plurality of participants, which can be used as wager amount in the video gaming event, special rules defined by said initializing user, choice of the initiating user specified in the form.

21. The method as claimed in claim 20, wherein the plurality of participants notified to participate in said online betting activity are sent with a notification request to every participant, which is associated with a unique contract number of said plurality of participants through a networking application, such as a social media application, a text application, an email application, or the like.

22. The method as claimed in claim 21, wherein the notification request sent to said plurality of participants to participate in said online betting activity can be either accepted or rejected by said plurality of participants.

23. The method as claimed in claim 15, wherein the information of said plurality of participants participating in said online betting activity is sent to a system database for verifying the wager amount available with said plurality of participants to participate in said online betting activity.

24. The method as claimed in claim 14, wherein the method initiates the fund transaction between said initializing user and said plurality of participants, who are declared to be the winners of the online betting activity associated with said at least one video gaming event, by updating the gamer tag and the unique contract number of the winners in the system database.

25. The method as claimed in claim 24, wherein the method notifies said plurality of participants with the winning/victory evidence by sharing the victory screenshots and ensures that the declared winner(s) receive the allotted funds.

26. The method as claimed in claim 14, wherein the method allows the user to perform any of the foreground activities while the system is sending notification to said plurality of participants within the network.
